(19) United States
(12) Patent Application Publication
(10) Pub. No.: US 2026/0025797 A1
(43) Pub. Date: Jan. 22, 2026

(54) CHANNEL SELECTION UTILIZING CHANNEL POWER

(71) Applicant: Charter Communications Operating, LLC, St. Louis, MO (US)

(72) Inventors: Pratiksha Shukla, Parker, CO (US); Taren McCullough, North Plymouth, MN (US)

(73) Assignee: Charter Communications Operating, LLC, St. Louis, MO (US)

(21) Appl. No.: 18/775,832

(22) Filed: Jul. 17, 2024

(51) Int. Cl. H04W 72/02; H04W 72/0453; H04W 72/541

(52) U.S. Cl. CPC H04W 72/02; H04W 72/0453; H04W 72/541

(57) ABSTRACT

In certain embodiments, an access point (AP) of a multi-channel (e.g., WiFi) communication network switches from operating at a current channel to operating at a new channel. The AP determines the current channel interference of the current channel and scans other channels to determine target channel utilizations of those other channels. The AP selects one of the other channels to be a new channel for the AP based on (i) the current channel interference, (ii) the target channel utilizations, and (iii) channel powers for the current channel and the other channels. By employing channel power, which typically varies with channel frequency, the AP avoids switching to a new channel at which the AP has diminished or no communication capability with one or more stations that are located at the edge of the AP's cell for the current channel.

### BACKGROUND

### Field of the Disclosure

The present disclosure relates to wireless communication systems and, more specifically but not exclusively, to channel selection in WiFi networks.

### Description of the Related Art

This section introduces aspects that may help facilitate a better understanding of the disclosure. Accordingly, the statements of this section are to be read in this light and are not to be understood as admissions about what is prior art or what is not prior art.

A conventional access point (AP) for a WiFi network is capable of communicating with stations (STAs) (e.g., WiFi-capable user equipment (UE)) over one or more different frequency bands, such as the 2.4 GHz (aka 2G), 5 GHz (aka 5G), and 6 GHz (aka 6G) bands, where each frequency band is divided into multiple, different channels, where some STAs may be 2G STAs that communicate with the AP in the 2G band, other STAs may be 5G STAs that communicate with the AP in the 5G band, and still other STAs may be 6G STAs that communicate with the AP in the 6G band. At any given time, the AP communicates with the 2G STAs using a single, selected 2G channel; with the 5G STAs using a single, selected 5G channel; and with the 6G STAs using a single, selected 6G channel.

In conventional WiFi technology, it is not unusual for multiple access points (APs) associated with different WiFi networks to be located sufficiently near one another such that AP transmissions may interfere with one another. For example, if two or more nearby APs transmit on the same 2G channel, then those transmissions may interfere with one another, thereby limiting the quality of the communications between a given AP and some or all of its STAs.

It is known for an AP to perform an Off-Channel Scan (OCS) to characterize the signal ecosystem in the currently selected channel and in other available channels to determine whether to select a new channel for its communications with its STAs. One conventional parameter used for this channel-selection function is station count, i.e., the total number of STAs currently transmitting in a given channel. Another conventional parameter is the number of APs currently operating on a given channel. Other conventional parameters include:
Current Channel Utilization: The percentage of time that the current channel is busy due to an AP's own traffic;
Current Channel Interference: The percentage of time that the current channel is busy due to the traffic of other APs or other interfering sources; and
Target Channel Utilization: The percentage of time that a different, available (aka target) channel is busy due to the traffic of other APs or other interfering sources.

Note that the characterization of the signal ecosystem may involve passive scanning (in which the AP sequentially tunes its radio to different channels and merely listens for channel activity, such as beacons, probe responses, and network utilization) and/or active scanning (in which the AP sequentially tunes its radio to different channels and transmits probe-any requests (i.e., probe requests with a null SSID name) to solicit responses from other APs operating on the tuned channel). In a typical OCS implementation, an AP will follow a longer (e.g., 1-sec) period of normal operations in the current WiFi channel with a shorter (e.g., 100-msec) period of scanning in an individual, other channel and then repeat that sequence with different other channels until all of the other channels have been scanned, before repeating the entire process either right away or after a specified delay. As known in the art, the scan dwell time and the time between scans can be manipulated in times of high traffic load or critical traffic delivery.

One or more of these conventional parameters may be used to determine a quality measure for each channel. If the channel quality of the current channel is lower than the channel quality of one of the target channels, then the AP is able to automatically switch from operating on the current channel to operating on that target channel as the new channel.

### SUMMARY

It is not unusual for one or more STAs to be so-called “edge-of-cell STAs” that are located at or near the edge of the coverage range of the AP with which the STAs are communicating. In those situations, when channel selection is based on such conventional parameters as station count, current channel utilization, current channel interference, and/or target channel utilization, switching to a target channel may leave one or more edge-of-cell STAs outside of the range of the AP operating at the new channel, thereby resulting in a loss of communication with the AP for those STAs. And even if an edge-of-cell STA is still within the range of the AP, the signal-to-noise ratio (SNR) of the resulting signals may significantly negatively impact the ability of that STA to communicate with the AP.

To address these problems, channel-selection techniques of the present disclosure take channel power into consideration when determining whether to change the operating channel and, if so, which target channel to select as the new channel.

In at least one embodiment of the present disclosure, a method for channel selection at an access point (AP) of a multi-channel communication network operating at a current channel The AP determines current channel interference of the current channel; scans one or more other channels to determine target channel utilizations of the one or more other channels; selects one of the other channels as a new channel for the AP based on (i) the current channel interference, (ii) the target channel utilizations, and (iii) channel powers for the current channel and the one or more other channels; and switches operations to the new channel.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified block diagram of a signal ecosystem in which the respective coverage areas of two APs operating in the same (i.e., current) channel overlap with one another;

FIG. 2 is a flow diagram of the processing performed by an AP, such as an AP of FIG. 1, according to certain embodiments of the disclosure;

FIG. 3 is a flow diagram representing the processing of step 220 of FIG. 2;

FIG. 4 is a flow diagram representing the processing of step 224 of FIG. 2;

FIG. 5 is a block diagram of the RF chain of an example WiFi AP, such as an AP of FIG. 1; and

FIG. 6 is a simplified hardware block diagram of an example node that can be used to implement any AP or STA of FIG. 1.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

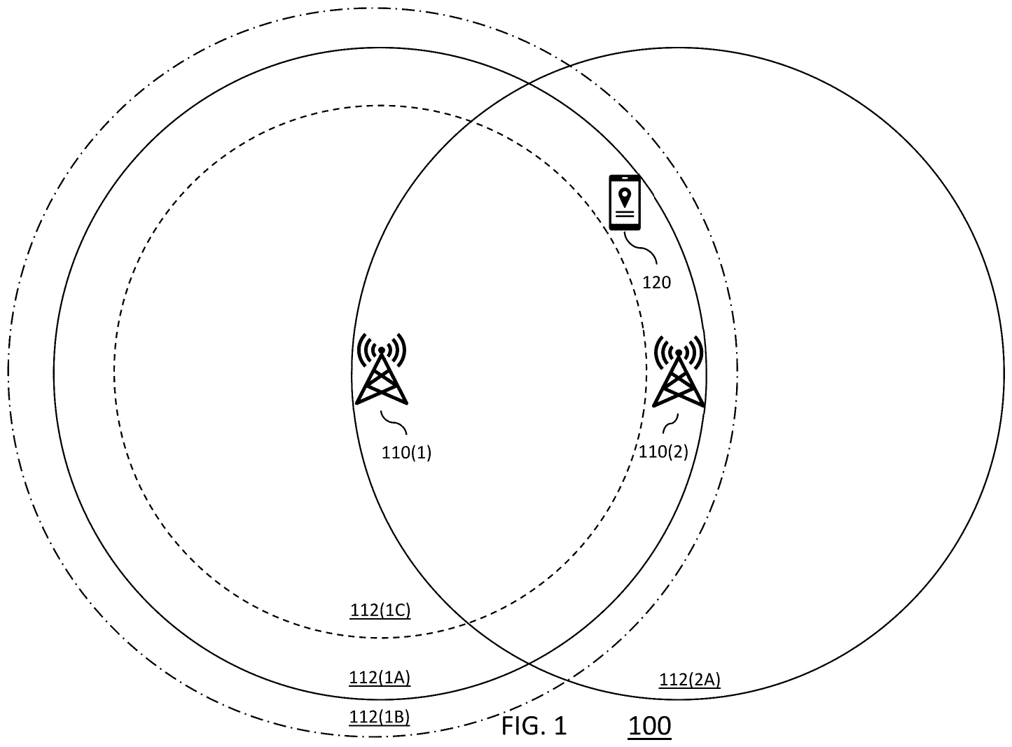

FIG. 1 is a simplified block diagram of a signal ecosystem 100 in which the respective coverage areas 112(1A) and 112(2A) of two APs 110(1) and 110(2) operating in the same (i.e., current) channel overlap with one another such that the transmissions of AP 110(2) in the current channel (aka Channel A) may interfere with the transmissions of AP 110(1) in that same Channel A. In that case, AP 110(1) may decide to switch to a different, target channel to avoid that interference.

As shown in FIG. 1, STA 120, which communicates with AP 110(1) in the current Channel A, is an edge-of-cell STA located near the outer range of AP 110(1)'s current-channel coverage area 112(1A). Although not explicitly shown in FIG. 1, those skilled in the art will understand that there may be any suitable number of other STAs associated with AP 110(1) and one or more STAs associated with AP 110(2). In addition, there may be one or more other nearby APs with still more associated STAs not explicitly shown in FIG. 1.

FIG. 1 also shows two other coverage areas associated with AP 110(1):
Coverage area 112(1B): AP 110(1)'s coverage area for target Channel B; and
Coverage area 112(1C): AP 110(1)'s coverage area for target Channel C.

As shown in FIG. 1, coverage area 112(1B) is larger than coverage area 112(1A), because the channel power level of AP 110(1) in Channel B is greater than the channel power level of AP 110(1) in Channel A. Similarly, coverage area 112(1C) is smaller than coverage area 112(1A), because the channel power level of AP 110(1) in Channel C is less than the channel power level of AP 110(1) in Channel A.

As shown in FIG. 1, STA 120 is located within coverage areas 112(1A) and 112(1B), but outside of coverage area 112(1C). This means that, if AP 110(1) were to switch to target Channel C, then AP 110(1) would lose communication with STA 120, but not if AP 110(1) were to switch to target Channel B.

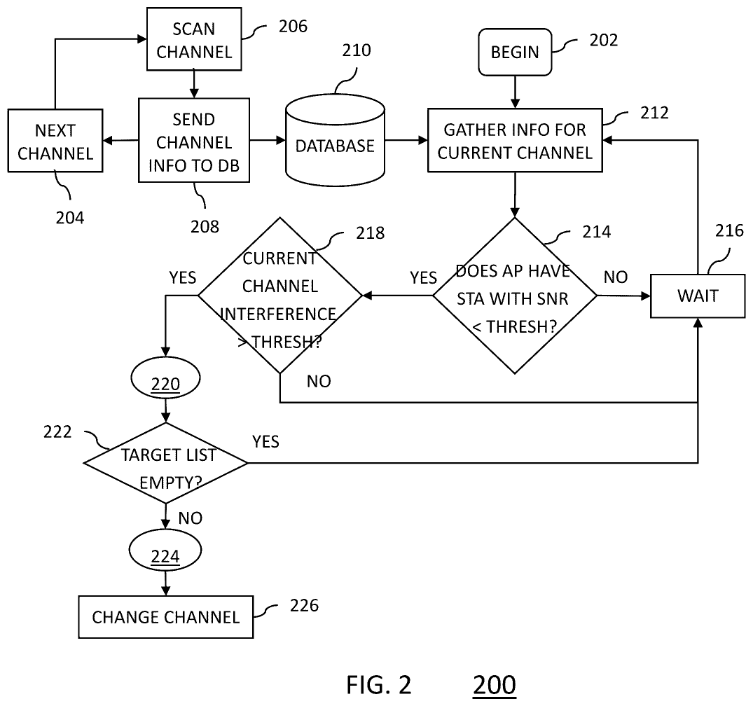

FIG. 2 is a flow diagram of the processing 200 performed by an AP, such as AP 110(1) or AP 110(2) of FIG. 1, according to certain embodiments of the disclosure. The following description applies to the processing 200 performed by the AP for a single multi-channel WiFi band, e.g., either 2G, 5G, or 6G. Those skilled in the art will understand that, depending on the implementation, the AP can perform the processing 200 of FIG. 2 sequentially or in parallel for multiple WiFi bands.

The processing 200 of FIG. 2 begins at step 202 and continues with steps 212-226. While the AP performs the processing of steps 212-226, the AP is also continuously or periodically (depending on the implementation) performing steps 204-208 in parallel with steps 212-226.

In step 204, the AP selects a particular channel in the multi-channel WiFi band. In step 206, the AP scans the selected channel using passive and/or active scanning to generate one or more parameters characterizing the signal ecosystem for the selected channel. In some implementations, if the channel selected in step 204 is the current channel being used by the AP to communicate with its STAs in its normal operating mode, then the parameters include the current channel utilization, the current channel interference, and the signal-to-noise ratio (SNR) associated with each of the AP's STAs. SNR is built from the received signal strength (RSSI) values measured by the STAs and reported back to the AP. From there the AP can measure the noise floor and build the SNR from that data. If the channel selected in step 204 is a channel other than the AP's current channel, then the parameters include the target channel utilization.

Note that both APs and STAs create interference on a channel. When the AP scans a channel for current channel interference, the AP will receive and attempt to decode signals on that channel that are generated from both APs and STAs, where WiFi (e.g., IEEE 802.11) signals will be decoded and non-WiFi signals will be marked.

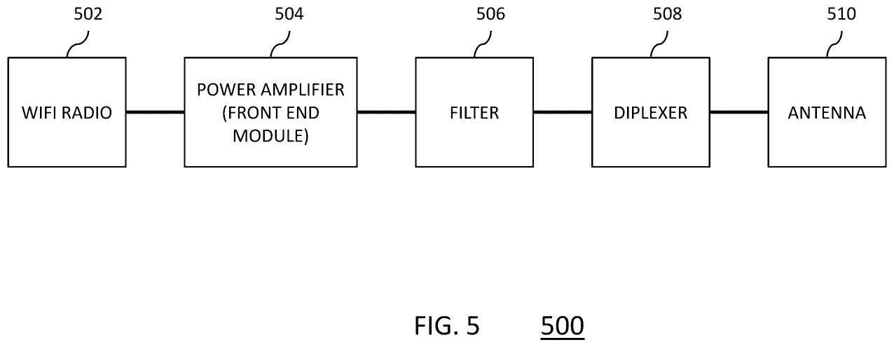

After scanning the selected channel, in step 208, the AP stores the generated parameters and any other scanning results in the database 210 and then returns to step 204 to select another channel for the next scanning iteration. In addition to storing the scanning results for each different channel, the database 210 stores a specified channel power value for each different channel. These specified channel power values are described further below in the context of FIG. 5.

In step 212, the AP retrieves from the database 210 information related to the current channel (i.e., the channel currently used in the AP's normal operations to communicate with its STAs). In step 214, the AP determines whether any of the STAs associated with the AP have an SNR value below a specified SNR threshold, which indicates that such a STA is assumed to be an edge-of-cell STA. If not, then no STA is assumed to be an edge-of-cell STA. In that case, it is assumed that the AP is communicating satisfactorily with all of its STAs using the current channel, and no switch to a different channel is needed. As such, processing proceeds to step 216, where the AP pauses for a specified duration (e.g., 5 minutes) before returning to repeat step 212 et seq. If, however, the AP determines in step 214 that at least one of the AP's STAs is an edge-of-cell STA, then processing proceeds to step 218.

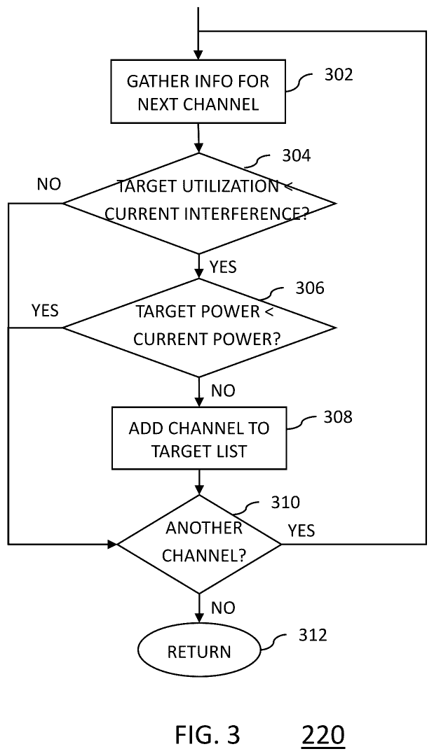

In step 218, the AP determines whether the current channel interference is greater than a specified interference threshold. If not, then the current channel interference is at an acceptable (i.e., low) level, and no switch to a different channel is needed. Here, too, processing proceeds to step 216, where the AP pauses for the specified duration before returning to step 212. If, however, the AP determines in step 218 that the current channel interference is greater than the specified interference threshold, then processing proceeds to step 220 of FIG. 3.

FIG. 3 is a flow diagram representing the processing of step 220 of FIG. 2. In step 220, the AP sequentially examines each of the other available channels to determine whether any of those other channels are candidates to be the new channel selected for the AP's operations. The processing of FIG. 3 begins at step 302, where the AP retrieves from the database 210 of FIG. 2 information related to the currently selected other channel.

In step 304, the AP determines whether the target channel utilization of that other channel is less than the current channel interference. If so, then that other channel may be suitable to be the new channel for the AP's operations and processing proceeds to step 306. Otherwise, that other channel is not suitable to be the AP's new channel and processing proceeds to step 310, where the AP determines whether there is another channel to examine. If so, then processing returns to step 302 to examine the next other channel. If the AP determines in step 310 that all of the other channels have been examined, then the processing of step 220 is completed, and, in step 312, processing proceeds to step 222 of FIG. 2.

In step 306, the AP determines whether the channel power of the other channel is less than the channel power of the current channel. If so, then switching to the other channel for the AP's operations may result in the AP losing communication with one or more of the AP's edge-of-cell STAs. In that case, the other channel is not suitable to be the AP's new channel and processing proceeds to step 310. Otherwise, the other channel is suitable to be the AP's new channel and processing proceeds to step 308, where the other channel is added to a list of suitable target channels before proceeding to step 310.

When the processing of step 220 of FIG. 3 is completed, all of the other available channels will have been examined and the list generated in step 308 will contain zero, one, or more target channels, each of which is suitable to be the AP's next channel.

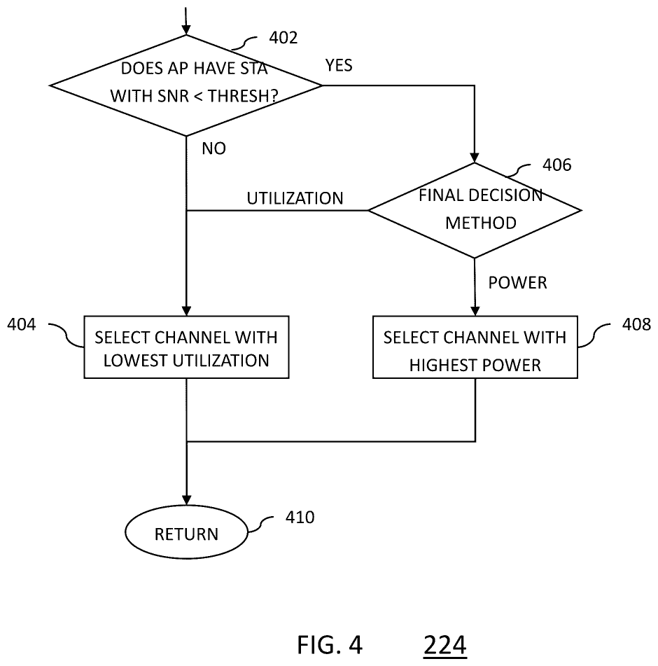

Returning to FIG. 2, in step 222, the AP determines whether the target list is empty. If so, then none of the other channels is suitable to be the AP's next channel and processing proceeds to step 216. Otherwise, the target list contains one or more suitable target channels and processing proceeds to step 224 of FIG. 4.

FIG. 4 is a flow diagram representing the processing of step 224 of FIG. 2. In step 224, the AP selects one of the suitable target channels to be the AP's next channel. The processing of step 224 begins at step 402, where the AP determines if any of the AP's STAs has an SNR below a specified SNR threshold. In other words, in step 402, the AP determines whether any of the AP's STAs are edge-of-cell STAs. Depending on the specified SNR threshold used, step 402 may be identical to step 214 of FIG. 2. Note that processing may have reached step 402 via either step 214 or via step 218 of FIG. 2.

If the AP does not have any edge-of-cell STAs, then processing continues to step 404, where the AP selects the target channel having the lowest target channel utilization to be the AP's next channel.

If the AP does have one or more edge-of-cell STAs, then processing continues to step 406. The AP can be configured (e.g., programmed) such that, at this stage of the processing, the AP's selection of its next channel can be based on either target channel utilization or channel power. If the AP is configured for target channel utilization, then processing proceeds to step 404. Otherwise, the AP is configured for channel power and processing proceeds to step 408, where the AP selects the target channel having the highest channel power to be the AP's next channel.

After the processing of step 224 of FIG. 4 is completed, in step 410, processing returns to step 226 of FIG. 2, where the AP switches from operating normally using its previously selected current channel to operating normally using the selected target channel from step 224 as its new channel for communicating with its STAs. Those skilled in the art will understand that the AP uses conventional WiFi processing to switch to the new channel.

By taking channel power into account, the AP can ensure that service is maintained to all connected STAs through the channel change. By identifying if the ecosystem has any edge-of-cell STAs, the AP can accurately decide which channel assessment method to use. In particular, if there are no edge-of-cell STAs, then the AP relies on only utilization analysis. On the other hand, if at least one edge-of-cell STA is present, then the AP can use either channel power or utilization analysis depending on the AP's configuration.

FIG. 5 is a block diagram of the RF chain 500 of an example WiFi AP, such as AP 110(1) or AP 110(2) of FIG. 1. As shown in FIG. 5, the AP's RF chain 500 includes WiFi radio 502, power amplifier 504, filter 506, diplexer 508, and antenna 510. Each of these components may operate slightly differently at different channel frequencies within a WiFi band, which collective differences can result in variance in overall channel power levels at those different channels. The major, but not only, contributor to this channel-power variance is typically the filter 506 having increased attenuation at the band edges compared to the center of the band. For example, in the WiFi 5G band, a filter's insertion loss at the 5170 MHz channel near the 5G band edge may be about 1.4 dB, while only about 1 dB at the 5225 MHz channel near the 5G band center.

According to certain embodiments of the disclosure, the overall channel power level at each channel in a given WiFi band is determined, e.g., during FCC testing, with those measured, channel-dependent power levels stored as the channel powers in the AP's memory, e.g., database 210 of FIG. 2. Those skilled in the art will understand that the power level values stored in database 210 may correspond to other power-related characteristics of the AP's channel-dependent operations, such as (without limitation) the power setting, the conducted power, or the total radiated power (TRP), each as a function of channel frequency.

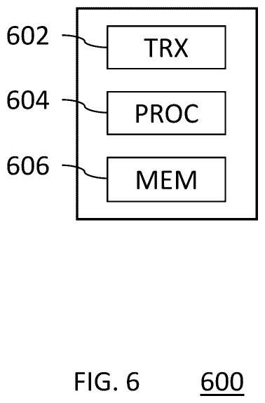

FIG. 6 is a simplified hardware block diagram of an example node 600 that can be used to implement any AP or STA of FIG. 1. As shown in FIG. 6, the node 600 includes (i) communication hardware (e.g., wireless, wireline, and/or optical transceivers (TRX)) 602 that supports communications with other nodes, (ii) one or more processors (e.g., CPU and/or GPU microprocessors) 604 that control the operations of the node 600 and/or process data within the node 600, and (iii) one or more memories (e.g., RAM, ROM) 606 that store code executed by the processors 604 and/or data generated and/or received by the node 600.

In certain embodiments, the present disclosure is a method for channel selection at an access point (AP) of a multi-channel communication network operating at a current channel The AP determines current channel interference of the current channel; scans one or more other channels to determine target channel utilizations of the one or more other channels; selects one of the other channels as a new channel for the AP based on (i) the current channel interference, (ii) the target channel utilizations, and (iii) channel powers for the current channel and the one or more other channels; and switches operations to the new channel.

In at least some of the above embodiments, before selecting the new channel, the AP determines that at least one station communicating with the AP on the current channel is an edge-of-cell station.

In at least some of the above embodiments, the AP determines that the at least one station is an edge-of-cell station based on signal-to-noise ratio (SNR) for the at least one station being below a specified SNR threshold level.

In at least some of the above embodiments, before selecting the new channel, the AP determines that the current channel interference is above a specified interference threshold level.

In at least some of the above embodiments, selecting the new channel comprises, for at least one other channel, the AP determining that the target channel utilization of the other channel is less than the current channel interference; determining that the channel power of the other channel is greater than or equal to the channel power of the current channel; and adding the other channel to a list of one or more target channels.

In at least some of the above embodiments, selecting the new channel further comprises the AP determining whether the AP has an edge-of-cell station; upon determining that the AP has an edge-of-cell station, selecting the target channel having the lowest target channel utilization as the new channel; and, upon determining that the AP has no edge-of-cell station, selecting either (i) the target channel having the lowest target channel utilization among the target channels with equal or higher channel power as the new channel or (ii) the target channel having the highest channel power as the new channel, depending on a configured final decision method.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A method for channel selection at an access point (AP) of a multi-channel communication network operating at a current channel, the method comprising the AP:
determining current channel interference of the current channel;
scanning one or more other channels to determine target channel utilizations of the one or more other channels;
selecting one of the other channels as a new channel for the AP based on (i) the current channel interference, (ii) the target channel utilizations, and (iii) channel powers for the current channel and the one or more other channels; and
switching operations to the new channel.

2. The method of claim 1, wherein, before selecting the new channel, the AP determines that at least one station communicating with the AP on the current channel is an edge-of-cell station.

3. The method of claim 2, wherein the AP determines that the at least one station is an edge-of-cell station based on signal-to-noise ratio (SNR) for the at least one station being below a specified SNR threshold level.

4. The method of claim 1, wherein, before selecting the new channel, the AP determines that the current channel interference is above a specified interference threshold level.

5. The method of claim 1, wherein selecting the new channel comprises, for at least one other channel, the AP:
determining that the target channel utilization of the other channel is less than the current channel interference;
determining that the channel power of the other channel is greater than or equal to the channel power of the current channel; and
adding the other channel to a list of one or more target channels.

6. The method of claim 5, wherein selecting the new channel further comprises the AP:
determining whether the AP has an edge-of-cell station;
upon determining that the AP has an edge-of-cell station, selecting the target channel having the lowest target channel utilization as the new channel; and
upon determining that the AP has no edge-of-cell station, selecting either (i) the target channel having the lowest target channel utilization among the target channels with equal or higher channel power as the new channel or (ii) the target channel having the highest channel power as the new channel, depending on a configured final decision method.

7. An access point (AP) comprising:
a memory; and
at least one processor, coupled to the memory and operative to:
determine current channel interference of the current channel;
scan one or more other channels to determine target channel utilizations of the one or more other channels;
select one of the other channels as a new channel for the AP based on (i) the current channel interference, (ii) the target channel utilizations, and (iii) channel powers for the current channel and the one or more other channels; and
switch operations to the new channel.

8. The AP of claim 7, wherein, before selecting the new channel, the AP is adapted to determine that at least one station communicating with the AP on the current channel is an edge-of-cell station.

9. The AP of claim 8, wherein the AP is adapted to determine that the at least one station is an edge-of-cell station based on SNR for the at least one station being below a specified SNR threshold level.

10. The AP of claim 7, wherein, before selecting the new channel, the AP is adapted to determine that the current channel interference is above a specified interference threshold level.

11. The AP of claim 7, wherein selecting the new channel comprises, for at least one other channel, the AP is adapted to:
determine that the target channel utilization of the other channel is less than the current channel interference;
determine that the channel power of the other channel is greater than or equal to the channel power of the current channel; and
add the other channel to a list of one or more target channels.

12. The method of claim 11, wherein selecting the new channel further comprises the AP being is adapted to:
determine whether the AP has an edge-of-cell station;
upon determining that the AP has an edge-of-cell station, select the target channel having the lowest target channel utilization as the new channel; and
upon determining that the AP has no edge-of-cell station, select either (i) the target channel having the lowest target channel utilization among the target channels with equal or higher channel power as the new channel or (ii) the target channel having the highest channel power as the new channel, depending on a configured final decision method.
